(19) United States
(12) Patent Application Publication
(10) Pub. No.: US 2021/0134325 A1
(43) Pub. Date: May 6, 2021

(54) ASSISTED MAGNETIC RECORDING MEDIUM AND MAGNETIC STORAGE DEVICE

(71) Applicants: SHOWA DENKO K.K., Tokyo (JP); TANAKA KIKINZOKU KOGYO K.K., Tokyo (JP); TOHOKU UNIVERSITY, Miyagi (JP)

(72) Inventors: Shin SAITO, Miyagi (JP); Takayuki FUKUSHIMA, Chiba (JP)

(21) Appl. No.: 17/079,856

(22) Filed: Oct. 26, 2020

(30) Foreign Application Priority Data
Oct. 31, 2019 (JP) 2019-198443

(51) Int. Cl. G11B 5/66

(52) U.S. Cl. CPC G11B 5/66

(57) ABSTRACT

The present invention is to provide an assisted magnetic recording medium including a substrate; an underlayer disposed on the substrate; a magnetic layer disposed on the underlayer and including an alloy having an L1₀-type crystal structure; and a pinning layer disposed in contact with the magnetic layer, wherein the pinning layer includes a granular structure, the granular structure containing magnetic particles and grain boundaries, wherein the magnetic particles contain Co, and wherein the grain boundaries contain Y₂O₃ and/or an oxide of lanthanoid.

### CROSS-REFERENCE TO RELATED APPLICATIONS

This application is based upon and claims priority to Japanese Patent Application No. 2019-198443, filed on Oct. 31, 2019, the entire contents of which are incorporated herein by reference.

### BACKGROUND OF THE INVENTION

### Field of the Invention

The disclosures herein relate to an assisted magnetic recording media and a magnetic storage device.

### Description of the Related Art

In recent years, the demand for higher capacity hard disk drives has been increasing.

However, current recording methods have made it difficult to increase the recording density of hard disk drives.

Assisted magnetic recording method is one of the technologies that have been extensively studied and attracted attention as the next generation of recording methods. The assisted magnetic recording method is a recording method in which magnetic information is written by irradiating a magnetic recording medium with near-field light or microwaves from a magnetic head and reducing the coercivity of the area irradiated with near-field light or microwaves locally. An assisted magnetic recording medium to which near-field light is irradiated is called a heat-assisted magnetic recording medium, and an assisted magnetic recording medium to which microwaves are irradiated is called a microwave assisted magnetic recording medium.

In an assisted magnetic recording method, for example, a high Ku material such as an FePt alloy having an L1₀-type crystal structure (constant Ku of approximately 7×10⁷ erg/cm³) and a CoPt alloy having an L1₀-type crystal structure (constant Ku of approximately 5×10⁷ erg/cm³) are used as magnetic materials constituting a magnetic layer.

If a high Ku material is used as a magnetic material constituting a magnetic layer, demagnetization caused by thermal-fluctuation can be suppressed because the KuV/kT increases. As a result, a signal-to-noise ratio (SNR) of an assisted magnetic recording medium can be improved.

Where Ku is a magnetic anisotropy constant of magnetic particles, V is the volume of magnetic particles, k is Boltzman constant, and T is an absolute temperature.

Patent Document 1 discloses an assisted magnetic recording medium having a substrate, an underlayer, and a magnetic layer including an alloy having an L1₀-type crystal structure as a main component, in this order. Here, the assisted magnetic recording medium has a pinning layer in contact with the magnetic layer. The pinning layer is formed of Co or an alloy formed mainly of Co.

### SUMMARY OF THE INVENTION

### Problems to be Solved by the Invention

However, in order to further improve the recording density of an assisted magnetic recording medium, further improvement of the SNR of the assisted magnetic recording medium has been required.

It may thus be desirable to provide an assisted magnetic recording medium with excellent SNR.

### RELATED ART DOCUMENTS

### Patent Documents

Patent Document 1: Japanese Patent Application Laid-Open No. 2018-147548

### Means for Solving Problems

(1) According to an embodiment, an assisted magnetic recording medium contains a substrate; an underlayer disposed on the substrate; a magnetic layer disposed on the underlayer and including an alloy having an L1₀-type crystal structure; and a pinning layer disposed in contact with the magnetic layer, wherein the pinning layer includes a granular structure, the granular structure containing magnetic particles and grain boundaries, wherein the magnetic particles contain Co, and wherein the grain boundaries contain Y₂O₃ and/or an oxide of lanthanoid.

(2) The assisted magnetic recording medium according to (1), wherein a following relationship is satisfied:

P_{Tc}−M_{Tc}≥200

wherein Curie temperature of the magnetic particles contained in the pinning layer is P_{Tc}[K], and Curie temperature of the alloy having the L1₀-type crystal structure is M_{Tc}.

(3) The assisted magnetic recording medium according to (1) or (2), wherein a thickness of the pinning layer is 1 nm or more and 10 nm or less.

(4) The assisted magnetic recording medium according to any one of (1) to (3), wherein the pinning layer is arranged on the magnetic layer.

(5) A magnetic storage device having the assisted magnetic recording medium of any one of (1) to (4).

### Effect of the Invention

According to at least one embodiment, an assisted magnetic recording medium with excellent SNR is provided.

### BRIEF DESCRIPTION OF THE DRAWINGS

FIG. 1 is a schematic view illustrating an example of an assisted magnetic recording medium according to an embodiment;

FIG. 2 is a schematic view illustrating an example of a magnetic storage device according to the embodiment; and

FIG. 3 is a schematic view illustrating an example of a magnetic head of, FIG. 2.

### DESCRIPTION OF THE PREFERRED EMBODIMENTS

While embodiments of the present invention will be described below, the present invention is not limited to the following embodiments, and various modifications and replacements can be made to the following embodiments without departing from the scope of the invention.

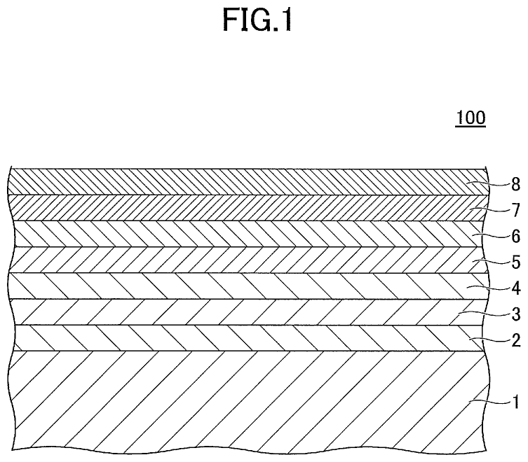

FIG. 1 illustrates an example of an assisted magnetic recording medium according to the present embodiment.

In the assisted magnetic recording medium 100, a seed layer 2, a first underlayer 3, a second underlayer 4, a magnetic layer 5, a pinning layer 6, a protective layer 7, and a lubricating film 8 are sequentially laminated on a substrate 1 in aforementioned order.

Here, the magnetic layer 5 includes an alloy having an L1₀-type crystalline structure, and an alloy having an L1₀-type crystalline structure is (001)-oriented.

The pinning layer 6 is in contact with the magnetic layer 5 and has a granular structure including magnetic particles and grain boundaries. Here, the magnetic particle is a particle containing Co, and the grain boundaries include Y₂O₃ and/or an oxide of lanthanoid. The pinning layer 6 has a function of pinning the direction of magnetization of the magnetic particles when magnetic information is written to the magnetic layer 5.

Generally, magnetic information is written to the magnetic layer by locally lowering the coercivity of the magnetic layer of the assisted magnetic recording medium by near-field light or microwave irradiated from the magnetic head. However, as a result of the effect of near-field light or microwave irradiation remaining in the magnetic layer immediately after the magnetic information is written, magnetization reversal occurs in some magnetic particles, causing noise.

For this reason, the pinning layer in contact with the magnetic layer is formed in the assisted magnetic recording medium disclosed in the Patent Document 1, and the magnetization reversal of the magnetic particles in the magnetic layer 5 immediately after writing the magnetic information can be suppressed.

Here, in the assisted magnetic recording medium of the Patent Document 1, the pinning layer having a granular structure including non-magnetic grain boundaries is formed in order to prevent causing write-blur at the time of writing magnetic information in the magnetic layer. This is to block the exchange coupling between the magnetic particles in the pinning layer and to prevent exchange coupling of the magnetic particles in the magnetic layer via the pinning layer.

However, leakage of magnetic fields from the non-magnetic grain boundaries in the pinning layer may cause noise. The effect of the magnetic field leakage is pronounced when a pinning layer is formed on the surface of the magnetic layer.

Therefore, in the assisted magnetic recording medium 100, the grain boundaries in the pinning layer 6 are formed by a slightly magnetized Y₂O₃ and/or an oxide of lanthanoid, and exchange coupling between the magnetic particles in the pinning layer 6 is slightly generated. Thus, it is possible to reduce magnetic field leakage from the grain boundaries in the pinning layer 6. This effect is noticeable at low temperature (at room temperature), as a result, noise generation can be prevented.

Examples of the lanthanoid in the oxide of the lanthanoid included in the grain boundaries of the pinning layer 6 include lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), and the like.

Examples of oxides of lanthanoid include La₂O₃, CeO₂, Ce₂O₃, Pr₆O₁₁, Nd₂O₃, Pm₂O₃, Sm₂O₃, Eu₂O₃, Gd₂O₃, Tb₂O₃, Tb₄O₇, Dy₂O₃, Ho₂O₃, Er₂O₃, Tm₂O₃, Yb₂O₃, Lu₂O₃, and the like.

In addition, since Y₂O₃ and/or an oxide of lanthanoid has a higher melting point than the material constituting the grain boundaries of the pinning layer of the assisted magnetic recording medium of the Patent Document 1 (for example, SiO₂, Cr₂O₃, TiO₂, B₂O₃, GeO₂, MgO, Ta₂O₅, CoO, Co₃O₄, FeO, Fe₂O₃, Fe₃O₄, etc.), the pinning layer 6 is planarized. When the pinning layer 6 is planarized, the surface of the assisted magnetic recording medium 100 is also planarized, so that the spacing loss between the magnetic head and the magnetic layer 5 is reduced, and thus the SNR of the assisted magnetic recording medium 100 is improved.

If Curie temperature of the magnetic particles included in the pinning layer 6 is P_{Tc}[K], and Curie temperature of the alloy having the L1₀-type crystal structure included in the magnetic layer 5 is M_{Tc}[K], then the following relationship

P_{Tc}−M_{Tc}≥200

is preferably satisfied,

P_{Tc}−M_{Tc}≥300

is more preferably satisfied, and

P_{Tc}−M_{Tc}≥500

is especially preferably satisfied.
When the following relationship satisfies

P_{Tc}−M_{Tc}≥200,

it is possible to more effectively suppress magnetization reversal of the magnetic particles in the magnetic layer 5 immediately after writing the magnetic information.

The optimum value of P_{Tc}−M_{Tc} depends on the material constituting the pinning layer 6, the thickness of the pinning layer 6, the material constituting the magnetic layer 5, the thickness of the magnetic layer 5, and the particle size distribution of the magnetic particles in the magnetic layer 5.

Curie temperature of a typical magnetic material is as follows.

### Co: 1388K

### Fe: 1044K

### Ni: 624K

FePt alloy: approximately 750K
SmCo₅ alloy: approximately 1000K
CoCrPt base alloy: 400 to 600K

From these values, the composition and Curie temperature of the magnetic particles in the pinning layer 6 can be determined. Of the practical magnetic materials, the highest Curie temperature is Co, so the highest values of P_{Tc} and P_{Tc}−M_{Tc} are obtained when the Co particles are used as the magnetic particles in the pinning layer 6. The magnetic particles in the pinning layer 6 are preferably Co particles, since the larger the P_{Tc}−M_{Tc}, the greater the effect of suppressing magnetization reversal of the magnetic particles in the magnetic layer 5 immediately after the magnetic information is written can be ensured.

A suitable range of P_{Tc}−M_{Tc} can be achieved by using a Co or CoFe alloy having a high Curie temperature as the material constituting the magnetic particles in the pinning layer 6.

Examples of the material constituting the magnetic particles in the pinning layer 6 include Co, CoFe alloy, CoPt alloy, CoB alloy, CoSi alloy, CoC alloy, CoNi alloy, CoPtB alloy, CoPtSi alloy, CoPtC alloy, CoGe alloy, CoBN alloy (non-granular structure), CoSi₃N₄ alloy (non-granular structure), and the like.

The material constituting the magnetic particles in the pinning layer 6 may include elements included in the magnetic layer 5 that is in contact with the pinning layer 6 or elements that have no appreciable effect on the magnetic layer 5 even if they diffuse into the magnetic layer 5.

When the magnetic particles in the pinning layer 6 are Co alloy particles, the content of elements other than Co (e.g., Fe, Pt, B, Si, C, Ni, Ge, N, etc.) in the Co alloy is preferably 15 at % or less, and more preferably 10 at % or less. When the content of elements other than Co in the Co alloy is 15 at % or less, the saturation magnetization of the Co alloy particles and/or the Curie temperature do not significantly decrease, so that the magnetization reversal of the magnetic particles in the magnetic layer 5 immediately after writing the magnetic information can be further suppressed.

The content of the grain boundaries in the pinning layer 6 is preferably from 10 to 50% by volume, and more preferably from 15 to 45% by volume. When the content of the grain boundaries in the pinning layer 6 is 10% to 50% by volume, the magnetic reversal of the magnetic particles in the magnetic layer 5 immediately after writing the magnetic information can be further suppressed.

The thickness of the pinning layer 6 is preferably 1 nm to 10 nm and more preferably 1 nm to 6 nm. When the thickness of the pinning layer 6 is 1 nm or more, the magnetization reversal of the magnetic particles in the magnetic layer 5 immediately after writing the magnetic information can be further suppressed. When the thickness of the pinning layer 6 is 10 nm or less, the magnetic field leakage from the grain boundaries in the pinning layer 6 can be further reduced.

The suitable thickness of the pinning layer 6 depends on the value of P_{Tc}−M_{Tc}, the material constituting the pinning layer 6, the material constituting the magnetic layer 5 and the thickness, the particle size distribution of the magnetic particles constituting the magnetic layer 5 and the like.

The upper limit of the thickness of the pinning layer 6 depends on the material constituting the magnetic particles in the pinning layer 6. When the magnetic particles are Co particles, the thickness of the pinning layer 6 is preferably 6 nm or less, and when the magnetic particles are Co alloy particles, the thickness of the pinning layer 6 is preferably 8 nm or less.

The pinning layer 6 may be formed on the substrate 1 side with respect to the magnetic layer 5, but is preferably formed on the side opposite to the substrate 1. As described above, since magnetic field leakage from the grain boundaries within the pinning layer 6 can be reduced, it is more effective that the pinning layer 6 is formed on the side closer to the magnetic head.

In addition, when the particles containing Co in the pinning layer 6 have a crystal structure other than an L1₀-type crystal structure such as an hcp structure, if the pinning layer 6 is formed on the side opposite to the substrate 1 with respect to the magnetic layer 5, the (001)-orientation of the magnetic layer 5 can be further improved.

The assisted magnetic recording medium 100 has a seed layer that is a single layer structure and an underlayer that is a laminated structure. That is, the seed layer 2, the first underlayer 3, and the second underlayer 4 are formed on the substrate 1 in this order. The seed layer 2, the first underlayer 3, and the second underlayer 4 are preferably lattice-matched with the magnetic layer 5 formed on the second underlayer 4. This further improves the (001)-orientation of the magnetic layer 5.

Examples of the material constituting the seed layer 2, the first underlayer 3, and the second underlayer 4 include Cr, W, MgO, and the like that are (100)-oriented.

The lattice misfit between each layer of the seed layer 2, the first underlayer 3, and the second underlayer 4 is preferably 10% or less.

The seed layer 2, the first underlayer 3, and the second underlayer 4, in which the lattice misfit between the layers is 10% or less, include, for example, a structure in which Cr, W, MgO, or the like, which is (100)-oriented, is laminated.

In order to ensure (100)-orientation of the seed layer 2, the first underlayer 3, and the second underlayer 4, a Cr layer, an alloy layer containing Cr with a bcc structure, or an alloy layer with a B2 structure may be formed under the seed layer 2, the first underlayer 3, or the second underlayer 4.

Examples of alloys containing Cr and having a bcc structure include CrMn alloys, CrMo alloys, CrW alloys, CrV alloys, CrTi alloys, CrRu alloys, and the like.

Examples of alloys having a B2 structure include RuAl alloys, NiAl alloys, and the like.

In order to improve lattice matching with the magnetic layer 5, an oxide may be included in the seed layer 2, the first underlayer 3, or the second underlayer 4, or any combination thereof.

The oxide is preferably an oxide of one or more elements selected from the group consisting of Cr, Mo, Nb, Ta, V, and W.

Examples of the oxide include CrO, Cr₂O₃, CrO₃, MoO₂, MoO₃, Nb₂O₅, Ta₂O₅, V₂O₃, VO₂, WO₂, WO₃, WO₆, and the like.

The content of oxide in the seed layer 2, the first underlayer 3, or the second underlayer 4 is preferably in the range of 2 to 30% by mol and more preferably in the range of 10 to 25% by mol. When the content of the oxide in the seed layer 2, the first underlayer 3, or the second underlayer 4 is 2% by mol or more, the (001)-orientation of the magnetic layer 5 can be further improved. When the content is 30% by mol or less, the (100)-orientation of the seed layer 2, the first underlayer 3, or the second underlayer 4 can be further improved.

Examples of the alloy having the L1₀-type crystal structure included in the magnetic layer 5 include FePt alloy, CoPt alloy, and the like.

In order to improve the (001)-orientation of the magnetic layer 5, the magnetic layer 5 is preferably heat-treated during the formation of the film. In this case, Ag, Au, Cu, Ni, or the like may be added to the alloy having the L1₀-type crystal structure to reduce the heating temperature.

Preferably, the alloy having the L1₀-type crystal structure contained in the magnetic layer 5 is of magnetically isolated magnetic particles. For this purpose, the magnetic layer 5 preferably further contains one or more substances selected from the group consisting of SiO₂, TiO₂, Cr₂O₃, Al₂O₃, Ta₂O₅, ZrO₂, Y₂O₃, CeO₂, GeO₂, MnO, TiO, ZnO, B₂O₃, C, B, and BN. This ensures that the exchange coupling between the magnetic particles is more reliably broken and further improves the SNR of the assisted magnetic recording medium 100.

The median diameter of the magnetic particles included in the magnetic layer 5 is preferably 10 nm or less from the viewpoint of improving the recording density of the assisted magnetic recording medium 100.

Generally, when the volume of the magnetic particles contained in the magnetic layer decreases, the magnetic layer 5 is susceptible to the influence of thermal-fluctuation immediately after writing the magnetic information.

However, since the pinning layer 6 is in contact with the magnetic layer 5, the direction of magnetization of the magnetic particles included in the magnetic layer 5 can be pinned. As a result, even though the median diameter of the magnetic particles included in the magnetic layer 5 is small, noise resulting from magnetic reversal of the magnetic particles in the magnetic layer 5 immediately after writing the magnetic information can be reduced, and thus the SNR of the assisted magnetic recording medium 100 can be improved.

The median diameter of the magnetic particles can be determined using the TEM observation image.

For example, the particle size (equivalent to a circle diameter) of 200 magnetic particles is measured from an observation image of TEM, and the particle size at the cumulative value of 50% is regarded as the median diameter.

The average value of the width of the grain boundaries included in the magnetic layer 5 is preferably between 0.3 nm to 2.0 nm.

The magnetic layer 5 has a single layer structure but may have a laminated structure.

In the magnetic layer having the laminated structure, for example, one or more kinds of materials selected from the group consisting of SiO₂, TiO₂, Cr₂O₃, Al₂O₃, Ta₂O₅, ZrO₂, Y₂O₃, CeO₂, GeO₂, MnO, TiO, ZnO, B₂O₃, C, B, and BN are laminated with different layers.

The thickness of the magnetic layer 5 is preferably 1 nm to 20 nm and more preferably 3 nm to 15 nm. When the thickness of the magnetic layer 5 is 1 nm or more, the reproducing output can be improved, and when the thickness is 20 nm or less, the enlargement of the magnetic particles can be suppressed.

In the case of a magnetic layer having a laminated structure, the thickness of the magnetic layer refers to the total thickness of all layers constituting the laminated structure.

In the magnetic recording medium 100, although a protective layer 7 is formed on the pinning layer 6, doing so is not necessary.

Examples of the material constituting the protective layer 7 are carbon and the like.

Examples of the forming method of the protective layer 7 include a Radio Frequency-Chemical Vapor Deposition (RF-CVD) method in which a raw gas made of hydrocarbon is decomposed by a high-frequency plasma, an Ion Beam Deposition (IBD) method in which a raw gas is formed by ionizing an electron emitted from a filament, and a Filtered Cathodic Vacuum Arc (FCVA) method in which a solid C target is used to form a film.

The thickness of the protective layer 7 is preferably 1 nm to 6 nm. When the thickness of the protective layer 7 is 1 nm or more, the floating characteristics of the magnetic head can be improved. When the thickness is 6 nm or less, the SNR of the assisted magnetic recording medium 100 can be further improved by reducing the magnetic spacing loss.

In the magnetic recording medium 100, although a protective layer 7 is formed on the lubricating film 8, doing so is not necessary.

The lubricating film 8 can be formed by applying a perfluoropolyether-based lubricant.

### [Magnetic Storage]

An example of a configuration of the magnetic storage device according to the present embodiment will be described.

The magnetic storage device according to the present embodiment includes an assisted magnetic recording medium according to the present embodiment.

The magnetic storage device according to this embodiment includes, for example, an assisted magnetic recording medium drive unit for rotating the assisted magnetic recording medium, a magnetic head for performing recording and reproducing operations on the assisted magnetic recording medium, a magnetic head drive unit for moving the magnetic head, and a recording/reproducing signal processing system.

The magnetic head includes, for example, a magnetic head with a near-field light generating element at the tip and a reproducing head with a reproducing element at the tip.

The recording head includes, for example, a laser light generator unit for heating an assisted magnetic recording medium and a near-field light generating unit including a waveguide for directing laser light generated from the laser generator unit to the near-field light generating element.

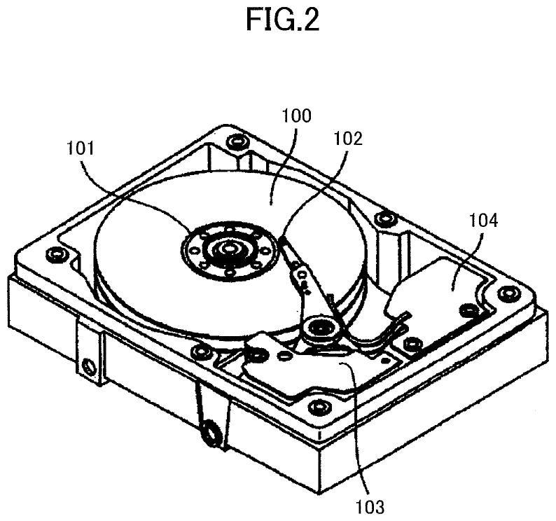

FIG. 2 illustrates an example of a magnetic storage device according to the present embodiment.

The magnetic storage device illustrated in FIG. 2 includes an assisted magnetic recording medium 100, an assisted magnetic recording medium drive unit 101 for rotating the assisted magnetic recording medium 100, a magnetic head 102, a magnetic head drive unit 103 for moving the magnetic head, and a recording/reproducing signal processing system 104.

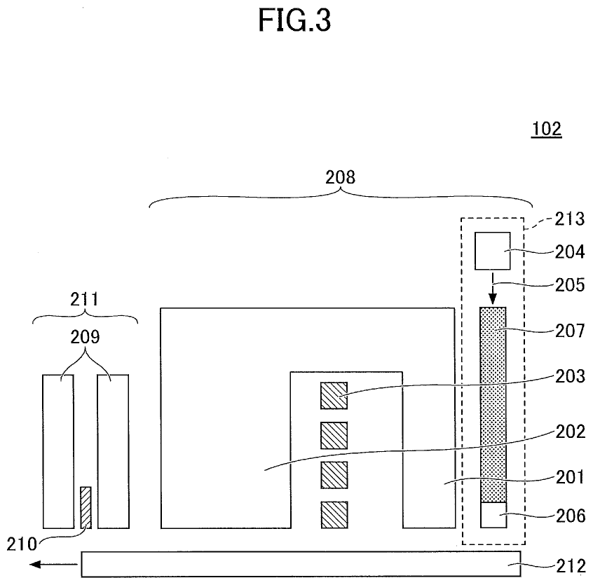

FIG. 3 illustrates a magnetic head 102 for a heat-assisted magnetic recording medium 212 as an example of a magnetic head 102.

The magnetic head 102 includes a recording head 208 and a reproducing head 211.

The recording head 208 includes a main pole 201, an auxiliary pole 202, a coil 203 for generating the magnetic field, and a near-field light generating unit 213. Here, the near-field light generating unit 213 includes a laser diode (LD) 204 and a waveguide 207 for transmitting the laser light 205 generated from the LD 204 to the near-field light generating element 206.

The reproducing head 211 has a reproducing element 210 sandwiched between the shields 209.

The description of the magnetic head for the microwave assisted magnetic recording medium is omitted because the near-field light generating unit 213 of the magnetic head 102 for the heat-assisted magnetic recording medium 212 is replaced with a microwave irradiating unit.

Since the magnetic storage device illustrated in FIG. 2 has the assisted magnetic recording medium 100, noise caused by writing magnetic information to the assisted magnetic recording medium 100 can be reduced. As a result, the SNR when reading magnetic information written on the assisted magnetic recording medium 100 can be improved. This can provide high recording density magnetic storage.

### EXAMPLES

Hereinafter, examples of the present invention will be described, but the present invention is not limited to the examples.

### Example 1

The assisted magnetic recording medium 100 (see FIG. 1) was prepared as follows.

A Cr-50 at % Ti alloy film (a film having Cr and 50% by atom of Ti alloy) with a thickness of 50 nm was formed on a glass substrate 1 with an outer diameter of 2.5 inches. Next, after the substrate 1 was heated to 350° C., a Cr film having a film thickness of 15 nm, a W film having a film thickness of 30 nm, and a MgO film having a film thickness of 3 nm were sequentially formed as the seed layer 2, the first underlayer 3, and the second underlayer 4, respectively. Then, after the substrate 1 was heated to 650° C., a (Fe-50 at % Pt)-40 mol % C film having a thickness of 2 nm and an 85 mol % (Fe-50 at % Pt)-15 mol % SiO₂ film having a thickness of 4.5 nm were sequentially formed as the magnetic layer 5. Here, the Curie temperature M_{Tc} of (Fe-50 at % Pt) particles as alloy particles having an L1₀-type crystalline structure was 700K. Next, a Co-20 vol % Dy₂O₃ film as the pinning layer 6 was formed. Here, the Curie temperature P_{Tc} of the Co particles as the magnetic particles included in the pinning layer 6 was 1300 K. Then, after forming the C film having a thickness of 4 nm as the protective layer 7, a perfluoropolyether-based lubricant having a thickness of 1.5 nm as the lubricating film 8 was applied to obtain the assisted magnetic recording medium 100.

### Examples 2 to 21, Comparative Examples 1 to 7

The assisted magnetic recording media were obtained in the same manner as Example 1, except that the materials and the thicknesses of the pinning layer 6 were changed as shown in Table 1.

### [Arithmetic Mean Roughness Ra of Pinning Layer]

After the pinning layer was formed, the substrate was removed and the arithmetic mean roughness Ra of the pinning layer was measured using AFM.

Next, the noise and SNR of the assisted magnetic recording medium were measured.

### [Noise, SNR]

The magnetic head 102 (see FIG. 3) was used to record an all-one pattern signal with a linear recording density of 1500 kFCI on the assisted magnetic recording medium, and noise and SNR were measured. Here, the power input to the laser diode was adjusted so that the half-maximum width (track width MWW) of the track profile was 60 nm.

Table 1 illustrates the measurement results of noise and SNR of the assisted magnetic recording media.

TABLE 1

| | Pinning Layer | | | | | | |
|---|---|---|---|---|---|---|---|
| | | Film | | | | | |
| | | thickness | Ra | P_{Tc} | P_{Tc}-M_{Tc} | Noise | SNR |
| | Materials | [nm] | [nm] | [K] | [K] | [mV] | [dB] |
| Example 1 | Co-20vol % Dy₂O₃ | 3 | 0.25 | 1300 | 600 | 0.080 | 11.5 |
| Example 2 | Co-20vol % Er₂O₃ | 3 | 0.25 | 1300 | 600 | 0.075 | 11.8 |
| Example 3 | Co-20vol % Eu₂O₃ | 3 | 0.26 | 1300 | 600 | 0.081 | 11.4 |
| Example 4 | Co-20vol % Gd₂O₃ | 3 | 0.24 | 1300 | 600 | 0.073 | 12.2 |
| Example 5 | Co-20vol % Nd₂O₃ | 3 | 0.24 | 1300 | 600 | 0.081 | 11.8 |
| Example 6 | Co-20vol % Sm₂O₃ | 3 | 0.25 | 1300 | 600 | 0.076 | 12.1 |
| Example 7 | Co-20vol % Tm₂O₃ | 3 | 0.26 | 1300 | 600 | 0.079 | 11.6 |
| Example 8 | Co-20vol % CeO₂ | 3 | 0.24 | 1300 | 600 | 0.081 | 11.3 |
| Example 9 | Co-20vol % Y₂O₃ | 3 | 0.26 | 1300 | 600 | 0.081 | 11.4 |
| Example 10 | (Co-5at % Fe)-20vol % | 3 | 0.27 | 1250 | 550 | 0.079 | 11.7 |
| | Y₂O₃ | | | | | | |
| Example 11 | (Co-10at % Fe)-20vol % | 3 | 0.28 | 1200 | 500 | 0.079 | 11.9 |
| | Y₂O₃ | | | | | | |
| Example 12 | Co-20vol % Y₂O₃ | 1 | 0.30 | 1300 | 600 | 0.082 | 11.3 |
| Example 13 | Co-20vol % Y₂O₃ | 6 | 0.24 | 1300 | 600 | 0.081 | 11.4 |
| Example 14 | Co-20vol % Y₂O₃ | 10 | 0.22 | 1300 | 600 | 0.084 | 11.3 |
| Example 15 | Co-10vol % Y₂O₃ | 3 | 0.27 | 1300 | 600 | 0.081 | 11.6 |
| Example 16 | Co-30vol % Y₂O₃ | 3 | 0.26 | 1300 | 600 | 0.085 | 11.3 |
| Example 17 | Co-40vol % Y₂O₃ | 3 | 0.28 | 1300 | 600 | 0.087 | 11.3 |
| Example 18 | (Co-5at % Pt)-7.5vol % | 3 | 0.24 | 1000 | 300 | 0.070 | 12.2 |
| | Gd₂O₃ | | | | | | |
| Example 19 | (Co-10at % B)-7.5vol % | 3 | 0.26 | 1000 | 300 | 0.075 | 12.0 |
| | Gd₂O₃ | | | | | | |
| Example 20 | (Co-10at % C)-5vol % | 3 | 0.24 | 1000 | 300 | 0.080 | 11.8 |
| | Gd₂O₃ | | | | | | |
| Example 21 | (Co-5at % Pd)-7.5vol % | 3 | 0.24 | 1000 | 300 | 0.070 | 12.1 |
| | Gd₂O₃ | | | | | | |
| Example 22 | 92.5(95Co-5Ge)-7.5Gd₂O₃ | 3 | 0.24 | 1000 | 300 | 0.072 | 12.3 |
| Comp. Example 1 | Co-20vol % CoO | 1.2 | 0.32 | 1300 | 600 | 0.093 | 11.2 |
| Comp. Example 2 | Co-20vol % CoO | 3 | 0.37 | 1300 | 600 | 0.093 | 11.2 |
| Comp. Example 3 | Co-6.5vol % Co₃O₄ | 1.2 | 0.33 | 1300 | 600 | 0.093 | 11.1 |
| Comp. Example 4 | Co-18vol % FeO | 1.2 | 0.33 | 1300 | 600 | 0.093 | 11.1 |
| Comp. Example 5 | Co-6vol % Fe₃O₄ | 1.2 | 0.34 | 1300 | 600 | 0.093 | 11.1 |
| Comp. Example 6 | Co-20vol % CoO | 1.0 | 0.32 | 1300 | 600 | 0.093 | 11.2 |
| Comp. Example 7 | Co-20vol % CoO | 1.5 | 0.34 | 1300 | 600 | 0.093 | 11.2 |

From Table 1, the assisted magnetic recording media of Examples 1 to 22 had a high SNR.

In contrast, the assisted magnetic recording media of Comparative Examples 1 to 7 had low SNR because the grain boundaries in the pinning layer did not contain Y₂O₃ or oxides of lanthanoid.

### DESCRIPTION OF THE REFERENCE NUMERALS

1 Substrate
2 Seed layer
3 First underlayer
4 Second underlayer
5 Magnetic layer
6 Pinning layer
7 Protective layer
8 Lubricating film
100 Assisted magnetic recording media
101 Assisted magnetic recording media drive unit
102 Magnetic head
103 Magnetic head drive unit
104 Recording/reproducing signal processing system
201 Main pole
202 Auxiliary pole
203 Coil
204 Laser diode
205 Laser light
206 Near-field light generating element
207 Waveguide
208 Recording head
209 Shield
210 Reproducing element
211 Reproducing head
212 Heat-assisted magnetic recording medium
213 Near-field light generating unit

What is claimed is:

1. An assisted magnetic recording medium comprising:
a substrate;
an underlayer disposed on the substrate;
a magnetic layer disposed on the underlayer and including an alloy having an L1₀-type crystal structure; and
a pinning layer disposed in contact with the magnetic layer,
wherein the pinning layer includes a granular structure, the granular structure containing magnetic particles and grain boundaries,
wherein the magnetic particles contain Co, and
wherein the grain boundaries contain Y₂O₃ and/or an oxide of lanthanoid.

2. The assisted magnetic recording medium according to claim 1, wherein a following relationship is satisfied:
P_{Tc}−M_{Tc}≥200
wherein Curie temperature of the magnetic particles contained in the pinning layer is P_{Tc}[K], and Curie temperature of the alloy having the L1₀-type crystal structure is M_{Tc}.

3. The assisted magnetic recording medium according to claim 1, wherein a thickness of the pinning layer is 1 nm or more and 10 nm or less.

4. The assisted magnetic recording medium according to claim 1, wherein the pinning layer is arranged on the magnetic layer.

5. A magnetic storage device having the assisted magnetic recording medium of claim 1.
